(19) United States
(12) Patent Application Publication
(10) Pub. No.: US 2026/0264443 A1
(43) Pub. Date: Sep. 10, 2026

(54) PERSONALIZABLE SECURITY DOCUMENT AND METHOD OF PERSONALIZING THE SAME

(71) Applicant: HID Global CID SAS, Suresnes (FR)

(72) Inventors: Nipun Sharma, Suresnes (FR); Carsten Senge, Bad Zwischenahn Bloh (DE)

(21) Appl. No.: 18/875,433

(22) PCT Filed: May 26, 2023
(86) PCT No.: PCT/EP2023/064194

§ 371 Date: Dec. 16, 2024

(30) Foreign Application Priority Data
Jul. 6, 2022 (EP) 22315134.1

(51) Int. Cl. B42D 25/41; B42D 25/23; B42D 25/351; B42D 25/373; B42D 25/387

(52) U.S. Cl. CPC B42D 25/41; B42D 25/23; B42D 25/351; B42D 25/373; B42D 25/387

(57) ABSTRACT

A personalizable security document (10) includes a laser-engravable portion (5a) that exhibits a color-change effect when viewed under white light. This color-change effect is used to selectively mask a further security feature provided as a first pattern (27a) in a layer that is below the layer including the laser-engravable portion (5a). This is achieved by appropriately matching the color of the laser-engravable portion (5a) to the color of the first pattern (27a).

### TECHNICAL FIELD

The present disclosure generally relates to security features for security documents, in particular, personalizable security documents such as identification documents, driver's licenses and the like.

### BACKGROUND

Generally, in the market of physical identification documents, a variety of different security features is used. In some applications, a laser engraved image is considered vital, as the image features are obtained inside a polycarbonate substrate rather than on the surface of the substrate. A laser engraved feature in a polycarbonate substrate may include a black and white (in particular, grayscale) image, a color image, or other special features.

There are also other approaches for providing security features for such identification documents or other security documents. For example, WO 2015/083099 A1 discloses a security structure comprising a layer containing a binder and goniochromatic metal particles inside the binder.

The present disclosure is directed, at least in part, to improving or overcoming one or more aspects of prior systems, without being limited to a particular type of security document.

### SUMMARY OF THE DISCLOSURE

According to one aspect of the present disclosure, a personalizable security document comprises a substrate having a first side and a second side opposite to the first side in a thickness direction of the substrate. The personalizable security document further comprises a security feature formed in the substrate and extending through at least part of the substrate along the thickness direction. The security feature includes a first layer including a laser-engravable portion configured to have an image laser engraved in the same. The laser-engravable portion includes a first material that exhibits a color-change effect when viewed from the first side under white light at different observation angles. The security feature further includes a second layer arranged below the first layer. The second layer includes a first pattern overlapping at least in part the laser-graving portion when viewed along the thickness direction. The first pattern has a color that is adapted to the first material of the laser-engravable portion such that the first pattern is not visible when the substrate is viewed from the first side under white light at a first observation angle, and the first pattern is visible when the substrate is viewed from the first side under white light at a second observation angle that is different from the first observation angle.

In another aspect of the present disclosure, a method of personalizing a security document comprises the steps of providing a personalizable security document in accordance with the above aspect, and laser engraving a personalized image in the laser-engravable portion from the first side of the substrate.

In a further aspect, the present disclosure relates to a personalized security document obtained by the method of the previous aspect.

Other features and aspects of the present disclosure will be apparent from the following description and the accompanying drawings.

### BRIEF DESCRIPTION OF THE DRAWINGS

FIG. 1 shows a plan view of an exemplary personalized security document in accordance with the present disclosure;

FIG. 2 is a sectional view showing a security feature provided in a security document in accordance with the present disclosure;

FIG. 3 is a schematic view illustrating a method of personalizing a security document in accordance with the present disclosure;

FIGS. 4 and 5 illustrate a front view and a rear view, respectively, of a security document when viewed under white light at a first observation angle;

FIG. 6 is a front view of the security document when viewed under white light at a second observation angle that is different from the first observation angle;

FIGS. 7 and 8 illustrate a front view and a rear view, respectively, of the security document when viewed against white light; and

FIGS. 9 and 10 illustrate a front view and a rear view, respectively, of the security document when viewed under UV light.

### DETAILED DESCRIPTION

The following is a detailed description of exemplary embodiments of the present disclosure. The exemplary embodiments described herein are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of protection. Rather, the scope of protection shall be defined by the appended claims.

The present disclosure is based at least in part on the realization that it may be advantageous to provide a security feature which combines different features in a single laserable window provided in a security document, for example, a polycarbonate card which is used as an identification document. It has been realized that a specialized ink can be used, which ink exhibits a color-change effect when viewed under white light at different observation angles. In this respect, it has been realized that it is particularly advantageous when the ink includes particles/pigments that give the security feature a first color when viewed under white light at a first observation angle, and a second, different color when viewed under white light at a second, different observation angle. When an additional security feature, for example, a watermark or the like is provided in another layer of the security document that is below the layer with the specialized ink, the color-change property of the ink allows for a selective masking of the additional security feature when viewed under white light from a first side of the security document. For example, the additional security feature may be configured to have the first color when viewed under white light, for example, from a back side of the security document. When the security document is viewed from the front side under white light at the first observation angle, the specialized ink may be configured such that it has substantially the same color as the watermark, and the watermark cannot be seen from the front side. However, when the security document is tilted by a prescribed angle, the color-change property of the particles/pigments inside the ink result in that the ink appears to have a second color that is different from the first color. If the ink is at least partially transparent to white light, light having the first color is reflected by the underlying additional feature, and the reflected light can pass through the layer included the specialized ink. Accordingly, the additional feature such as the watermark becomes visible when the security document is viewed from the front side at the second observation angle.

In addition, the present disclosure is based on the realization that a selection of appropriate particles for the specialized ink, and/or a provision of an additional colored layer on top of the particles having the color-change effect, allows for creating a desired color of the feature exhibiting the color-change effect, for example, when viewed at the first observation angle. For example, an appropriate organic material can be used in combination with metallic particles that have the color-change property. In addition, the organic material may result in an additional effect of changing the observed color when the security feature is personalized, for example, by irradiation with laser light. For example, prior to personalization, the layer including the mixture of metallic particles and the organic material may have a first color, and when the feature is personalized, the first color may gradually change to different colors with varying laser power. The resulting colors after personalization may then again have the color-change effect due to the presence of the metallic particles.

It has also been realized that, using an appropriate configuration of the specialized ink, a color-change effect can also be obtained when the security document is viewed from the back side, i.e., the side that is opposite to the side on which the personalized feature is present. In this case, the color-change effect results in a change of a background color against which the additional feature (i.e., the watermark or the like) is seen when viewed from the back side under white light. While this effect may be subtle, it is an additional feature that makes the security document more secure.

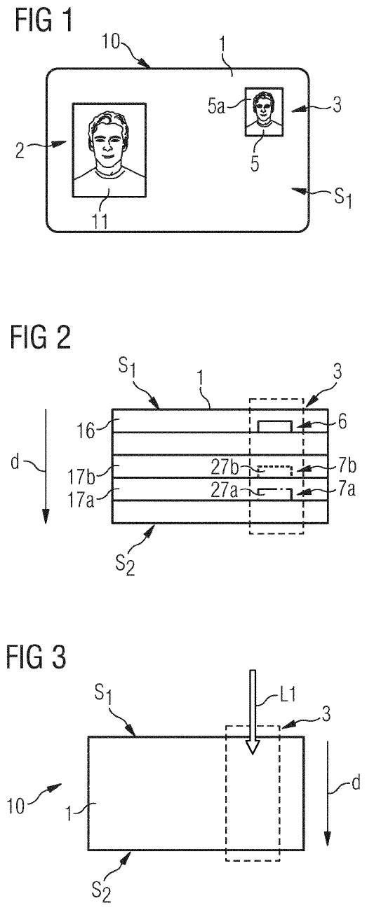

FIG. 1 shows a plan view of an exemplary security document 10 in accordance with the present disclosure. As shown in FIG. 1, security document 10 includes a substrate 1, for example, a polycarbonate or PVC substrate having a substantially rectangular shape. In particular, as shown in FIG. 1, security document 10 may be a personalized security document, i.e. include an image 11 (for example, a photograph or the like) of a person to which the document belongs. Image 11 may be formed in an image region 2 provided on a first side S1 of substrate 1 in a known manner.

In addition, as shown in FIG. 1, document 10 includes a security feature 3 formed in substrate 1, for example, in the shape of a rectangular window in which one or more security features can be provided. For example, as shown in FIG. 1, security feature 3 may include a laser engraved image 5, which may correspond to image 11 (for example, may be an inverse or negative of image 11), in a laser-engravable portion 5a of security feature 3.

It will be appreciated that, after manufacturing, security document 10 may be a personalizable security document. In other words, image region 2 and laser-engravable portion 5a may be empty, such that security document 10 is not personalized. Generally, such personalization will be carried out by the respective issuers of the security documents, for example, passports, identification cards, driver's licenses or the like.

FIG. 2 shows a schematic sectional view of a personalizable security document 10 in accordance with the present disclosure. As shown in FIG. 2, personalizable security document 10 comprises substrate 1 having first side S1 and a second side S2 opposite to first side S1 in a thickness direction d of substrate 1. For example, substrate 1 is formed by stacking a plurality of layers, for example, polycarbonate or PVC layers and combining them in an appropriate manner, for example, by lamination processes or the like. This is known to the skilled person, such that a detailed description will be omitted herein.

Security feature 3 is formed in substrate 1 and extends through at least part of substrate 1 along thickness direction d. In the example shown in FIG. 2, security feature 3 extends from the uppermost layer to the second layer from the bottom of substrate 1. In some embodiments, at least the portion of each layer in which security feature 3 is formed is substantially transparent or at least semi-transparent for visible light.

In the embodiment shown in FIG. 2, security feature 3 includes a first layer 16 including laser-engravable portion 5a, which is configured to have image 5 laser engraved in the same. For example, laser-engravable portion 5a is formed by a laser-engravable ink 6 provided in first layer 16. In one example, ink 6 may be formed on a bottom surface of first layer 16, for example, by screen printing or the like. However, it will be appreciated that, in other embodiments, ink 6 may be formed on a top surface of first layer 16. First layer 16 may be covered by one or more protective layers (not shown). In other applications, first layer 16 may be the top layer of the stack of layers of substrate 1. In any case, first layer 16 is configured such that image 5 can be laser engraved in laser-engravable ink 6 by using an appropriately configured laser. This will be described in more detail below.

Security feature 3 further includes a second layer 17a arranged below first layer 16, for example, with one or more intermediate layers provided between layers 16 and 17a. It will be appreciated, however, that the intermediate layer(s) can also be omitted in other embodiments. Second layer 17a includes a first pattern 27a overlapping at least in part laser-engravable portion 5a when viewed along the thickness direction, as shown in FIG. 2. In other words, when viewed from the first side S1 in a direction perpendicular to the substrate surface, laser-engravable ink 6 at least partially (or fully) covers first pattern 27a, which may be formed by an ink 7a. Preferably, ink 7a may be non-laserable, such that the properties of first pattern 27a are not affected when laser engraving of laser-engravable ink 6 is performed.

Laser-engravable portion 5a includes a first material that exhibits a color-change effect when viewed from first side S1 under white light at different observation angles. In some embodiments, the first material is formed by laser-engravable ink 6 provided in first layer 16. Generally, such laser-engravable inks having a color-change effect are known, for example, from WO 2015/083099 A1. As described in said document, such a laser-engravable ink is essentially formed from metallic particles that provide a color-change or goniochromatic effect. In accordance with the present disclosure, such goniochromatic particles are used in combination with an organic material, for example, an organic layer formed on top of the layer including the goniochromatic particles, or a coating of the metallic particles, or a mixture of the goniochromatic particles with additional (for example, organic) pigments to obtain an ink 6 that has a desired first color when viewed at a first observation angle prior to personalization. Preferably, a ratio between the organic material and the metallic particles is between 1:2 and 2:1, for example, around 1:1. This configuration results in that, when personalizable document 10 is viewed from first side S1 under white light at the first observation angle, for example, substantially 90 degrees, laser engravable-portion 5a (i.e., laser-engravable ink 6) is observed as having the first color.

First pattern 27a may be formed in or may be printed onto second layer 17a by screen printing or offset printing, and is configured to have a color that is essentially the same as the first color of laser-engravable portion 5a when viewed at the first observation angle. This results in that, when personalizable security document is viewed from the first side S1 at the first observation angle, laser-engravable portion 5a completely obscures first pattern 27a. In other words, first pattern 27a is not visible when substrate 1 is viewed from first side S1 under white light at the first observation angle. On the other hand, first pattern 27a may be visible when substrate 1 is viewed from first side S1 under white light at a second observation angle that is different from the first observation angle. For example, when substrate 1 is tilted, the color-change effect of ink 6 results in that the color of laser-engravable portion 5a changes. As laser-engravable portion 5a is at least partially transparent, part of the white light is transmitted through laser-engravable portion 5a and reflected by first pattern 27a having the first color. Accordingly, first pattern 27a can be seen when substrate 1 is tilted such that the color of laser-engravable portion 5a changes. It should be appreciated, as explained in more detail below, that this effect remains after personalization of security document 10. In other words, the personalization will not completely destroy the color-change effect that can be observed. For example, while some of the laser-processed portions of laser-engravable portion 5a may have a reduced or eliminated color-change effect, at least some portions of laser-engravable portion 5a will maintain at least a reduced color-change effect, allowing for the selective masking of at least portions of first pattern 27a.

As shown in FIG. 2, as an additional feature, security feature 3a may include a third layer 17b arranged above (or below) second layer 17a. Third layer 17b includes a second pattern 27b overlapping at least in part laser-engravable portion 5a when viewed along the thickness direction. Second pattern 27b is configured such that it is visible at least in part when substrate 1 is viewed from first side S1 and/or second side S2 under UV light. Preferably, second pattern 27b is formed by a fluorescent ink 7b, preferably a non-laserable ink, provided in third layer 17b. In the example shown in FIG. 2, third layer 17b is arranged between first layer 16 and second layer 17a. It will be appreciated that use of second pattern 27b results in additional security for document 10, because a given pattern formed by second pattern 27b can be observed when document 1 is viewed under UV light. In some embodiments, this effect can be enhanced by providing one or more further layers including one or more further patterns that are visible when viewed under UV light. Fluorescent inks that result in emission of light, for example, in the visible spectrum upon irradiation with UV light are well-known, such that a detailed description will be omitted.

As previously mentioned, laser-engravable portion 5a is formed by a laser-engravable ink 6, the transparency of which can be changed by irradiation of laser light of a particular wavelength and having different laser intensity. In some examples, a grayscale image may be engraved by varying the laser power between a minimum value and a maximum value corresponding to grayscale values between 0 and 255. In this manner, for example, a negative (inverted) image of image 11 shown in FIG. 1 can be engraved in laser-engravable ink 6 by an appropriate laser engraving apparatus. It will be appreciated that ink 6 is not particularly limited, as long as it is suitable for laser engraving and has a color-change effect. For example, ink 6 may be modified such that each pixel in the engraved image has a different color value, depending on the grayscale value of a grayscale image to be engraved. For example, a color value of blue may correspond to white in the grayscale image to be engraved, and a color value of gold may correspond to black in the grayscale image to be engraved. In other words, in the example, a minimum laser power results in that ink 6 remains blue, whereas a maximum laser power results in that ink 6 turns golden. However, it will be appreciated that this is only an example, and other materials that result in different colors may be employed.

An exemplary method of engraving laser-engraved image 5 is schematically shown in FIG. 3. As shown in FIG. 3, laser light L1 is irradiated from first side S1 of substrate 1 in the thickness direction to change the properties of laserable ink 6 (for ease of illustration, the respective layers and inks are not shown in FIG. 3). Here, it is important to use a laser power which is not too high, but sufficient to change the properties of laserable ink 6. If the power of laser light L1 were too high, at least part of security feature 3 shown in FIG. 2 would be destroyed. Accordingly, individual features, which will be described in more detail in the following, could no longer be observed.

As previously mentioned, ink 6 includes goniochromatic particles that result in the desired color-change effect. Moreover, an additional color layer, or additional pigments are provided for ink 6 in order to provide laser-engravable portion 5a and personalized image 5 with a desired color or colors. For example, initially, laser-engravable portion 5a may have a first color (for example, blue). As previously described, the presence of the goniochromatic particles inside ink 6 results in that, when substrate 1 is tilted, the color of laser-engravable portion 5a changes (for example, from blue to green). Upon personalization of document 10, depending on the laser power, for example, the goniochromatic effect of the particles inside the ink 6, and/or the transparency of the ink 6 may be reduced. For example, different portions of laser-engravable portion 5a may exhibit different amounts of color-change. Additionally, a further color change may result due to the presence of the additional pigments inside ink 6. For example, when viewed at the first observation angle, the initial color of laser-engravable portion 5a may gradually change with increasing laser power. In this manner, image 5 that may correspond to image 11 formed in image region 2 can be engraved in laser-engravable portion 5a.

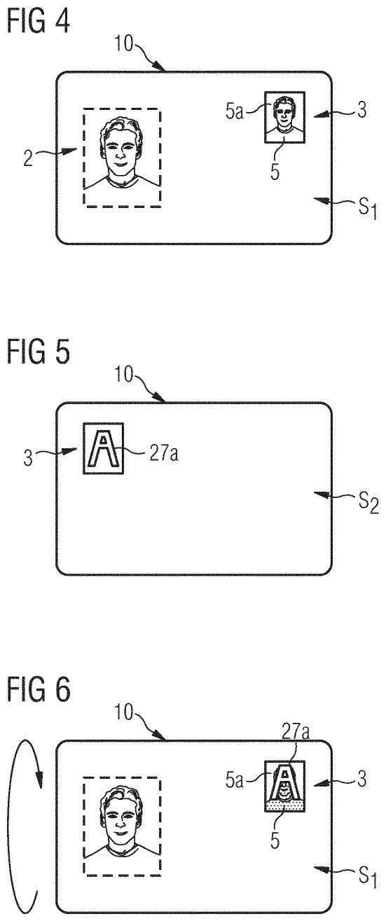

As shown in FIG. 4, when document 10 is viewed from first side S1 under white light, image 5 can be seen. Image 5 may have regions of different contrast due to the different laser powers used for engraving. In addition, some or all of image 5 may exhibit the above-described color-change effect. For example, this could be obtained by engraving image 5 as a negative image, i.e., processing the background of image 5 such that, for example, the color-change effect is reduced or completely eliminated. As a result, the foreground forming image 5 exhibits the color-change effect, with different portions of foreground image 5 having different contrast in order to represent the features in image 5.

As shown in FIG. 5, when document 10 is viewed from second side S2 opposite to first side S1, first pattern 27a is visible when viewed under white light. However, image 5 formed in laser-engravable portion 5a is not visible, because image 5 is generally formed in the upper part of laser-engravable portion 5a, i.e., there are no regions having different contrast or color on the back side of laser-engravable portion 5a.

FIG. 6 shows document 10 when viewed from first side S1 at a second observation angle that is different from the first observation angle in FIG. 4 (indicated by the arrow in FIG. 6). As shown in FIG. 6, when document 10 is tilted, image 5 appears to have a second, different color when compared to FIG. 2. In addition, first pattern 27a, which may be formed as a watermark in a known manner, becomes visible from first side S1 when viewed under white light. This is because first pattern 27a, as explained above, is configured such that is has the same color in reflection as the first color that is visible when document 10 is viewed from first side S1 at the first observation angle shown in FIG. 4. Laser-engravable portion 5a obscures first pattern 27a in FIG. 4, while no longer obscuring first pattern 27a in FIG. 6 due to the change in its color. In order to achieve this effect, the pigments in ink 6 and the material for first pattern 27a need to be chosen in an appropriate manner such that ink 6 has the first color that is more or less the same as the color of first pattern 27a, and has a sufficiently different second color when substrate 1 is tilted by a given angle. As previously mentioned, this effect may be obtained by configuring ink 6 to include metallic particles, for example, aluminum particles, covered by one or more metal or metal oxide layers, in addition to organic material, which may have the form of a layer provided on top of the metallic material, or pigments that are distributed in ink 6. For example, commercially available pigments may be used to obtain the desired effect.

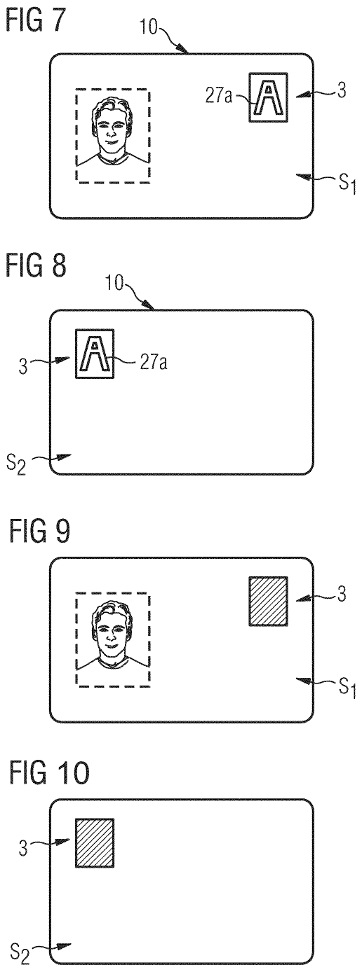

As shown in FIGS. 7 and 8, first pattern 27a is also visible when substrate 1 is viewed from first side S1 and from second side S2 against white light. In other words, first pattern 27a appears as a commonly used watermark. It will be appreciated, however, that this is just an example, and it is not necessary that first pattern 27a is such a watermark. For example, it is sufficient that first pattern 27a can only be seen when document 1 is viewed from first side S1 at the appropriate tilting angle, and is otherwise completely obscured both from the front side and from the back side irrespective of the viewing modes.

As shown in FIGS. 9 and 10, in some embodiments, security feature 3 is configured such that the entire region of security feature 3 is no longer visible when document 10 is viewed under UV light from first side S1 and from second side S2, in other words, security feature 3 may appear as a black patch. In other embodiments, first pattern 27a (and/or second pattern 27b) may be visible when substrate 1 is viewed from first side S1 and/or second side S2 under UV light. In other words, laser-engravable portion 5a may be configured to be completely transparent for UV light, and first pattern 27a and/or second pattern 27b may emit light, as described above, such that only first pattern 27a and/or second pattern 27b is visible under UV light.

In some embodiments, laser-engravable portion 5a, in particular, ink 6, may be configured such that security feature 3 exhibits a color-change effect when substrate 1 is viewed from second side S2 under white light at different observation angles. In particular, such a color-change effect may include a change of color of a background of first pattern 27a that is visible when substrate 1 is viewed from second side S2 under white light. In other words, at least the portion of second layer 17a that does not form first pattern 27a may be partially transparent, and the light that is reflected by the back side of laser-engravable portion 5a may appear to be of different color due to the goniochromatic metal particles and the additional pigments inside the same.

An appropriately configured (personalized) security document 10 in accordance with the present disclosure can exhibit the following effects. In other words, once laser-engraved image 5 has been successfully engraved in first layer 16, image 5a and pattern 27a (in addition to pattern 27b, if present), which are included in the respective layers, can be observed in different modes.

For example, when personalized security document 10 is viewed from first side S1 under white light, engraved image 5 is visible, which engraved image 5 exhibits the above-described color-change effect as a first security feature. As a second security feature, first pattern 27a can be selectively seen from first side S1 when security document 10 is viewed under white light. This results in additional security for the document.

In addition, first pattern 27a, which may be formed as a watermark, is visible when document 10 is viewed against white light from both sides. Moreover, when document 10 is viewed from second side S2, the specific properties of ink 6 may result in that a further color-change effect can be seen in a background of first pattern 27a. Additionally, security feature 3 may be configured such that one or more further effects can be observed when document 10 is viewed under UV light.

### Industrial Applicability

With the above-described configurations, a security document such as an ID card, a driver's license or the like having a security feature which includes a combination of different features can be obtained. In particular, the security of such a document can be enhanced by a selective masking of a further structure such as a watermark or the like by the personalizable portion of the security document, which personalizable portion exhibits a color-change effect.

Due to the combination of the different security features, it becomes very difficult to successfully forge such a security document.

A personalizable security document obtained with the above-described methods may be personalized by laser engraving personalized image 5 in laser-engravable portion 5a from first side S1 of substrate 1, as described above with reference to FIG. 3. As a result, a personalized security document 10 can be obtained, which includes security feature 3 having the above-described features.

It will be appreciated that the foregoing description provides examples of the disclosed systems and methods. However, it is contemplated that other implementations of the disclosure may differ in detail from the foregoing examples. All references to the disclosure or examples thereof are intended to reference the particular example being discussed at that point and are not intended to imply any limitation as to the general disclosure.

Recitation of ranges of values herein are merely intended to serve as a shorthand method for referring individually to each separate value falling within the range, unless otherwise indicated herein, and each separate value is incorporated into the specification as if it were individually recited herein. All method steps described herein can be performed in any suitable order, unless otherwise indicated or clearly contradicted by the context.

Although the preferred embodiments of the present disclosure have been described herein, improvements and modifications may be incorporated without departing from the scope of the following claims.

1. A personalizable security document comprising:
a substrate having a first side and a second side opposite to the first side in a thickness direction of the substrate; and
a security feature formed in the substrate and extending through at least part of the substrate along the thickness direction, wherein the security feature includes:
a first layer including a laser-engravable portion configured to have an image laser engraved therein, the laser-engravable portion including a first material that exhibits a color-change effect when viewed from the first side under white light at different observation angles; and
a second layer arranged below the first layer, the second layer including a first pattern overlapping at least in part the laser-engravable portion when viewed along the thickness direction;
wherein the first pattern has a color that is adapted to the first material of the laser-engravable portion such that the first pattern is not visible when the substrate is viewed from the first side under white light at a first observation angle, and the first pattern is visible when the substrate is viewed from the first side under white light at a second observation angle that is different from the first observation angle.

2. The security document of claim 1, wherein the first pattern is visible when the substrate is viewed from the second side under white light.

3. The security document of claim 1, wherein the first pattern is visible when the substrate is viewed from the first side against white light.

4. The security document of claim 1, wherein the first pattern is visible when the substrate is viewed from the second side against white light.

5. The security document of claim 1, wherein the first pattern is visible when the substrate is viewed from at least one of the first side under UV light or the second side under UV light.

6. The security document of claim 1, wherein the security feature exhibits a color-change effect when the substrate is viewed from the second side under white light at different observation angles.

7. The security document of claim 6, wherein the color-change effect when the substrate is viewed from the second side under white light at different observation angles includes a change of color of a background of the first pattern.

8. The security document of claim 1, wherein the security feature further includes a third layer arranged above or below the second layer, the third layer including a second pattern overlapping at least in part the laser-engravable portion when viewed along the thickness direction, wherein the second pattern is visible at least in part when the substrate is viewed from the second side under UV light.

9. The security document of claim 8, wherein the second pattern is formed by a fluorescent ink provided in the third layer.

10. The security document of claim 1, wherein the first pattern is printed onto the second layer by at least one of screen printing or offset printing.

11. The security document of claim 1, wherein the laser-engravable portion is formed by a laser-engravable ink provided in the first layer.

12. The security document of claim 1, wherein the security feature extends through the substrate from the first side to the second side.

13. The security document of claim 1, wherein the laser-engravable portion includes a combination of a metallic material and an organic material.

14. The security document of claim 13, wherein the metallic material includes a plurality of metallic particles.

15. A method of personalizing a security document, the method comprising:
providing a personalizable security document in accordance with claim 1; and
laser engraving a personalized image in the laser-engravable portion from the first side of the substrate.

16. The method of claim 15, wherein the security feature further includes a third layer arranged above or below the second layer, the third layer including a second pattern overlapping at least in part the laser-engravable portion when viewed along the thickness direction, wherein the second pattern is visible at least in part when the substrate is viewed from the second side under UV light.

17. The security document of claim 9, wherein the second pattern is formed by a non-laserable ink provided in the third layer.

18. The security document of claim 13, wherein the laser-engravable portion includes an organic layer comprising the organic material formed on top of the metallic material.

19. The security document of claim 13, wherein the laser-engravable portion includes an organic layer comprising the organic material formed on top of the metallic material with a ratio between 1:2 and 2:1.

20. The security document of claim 14, wherein the metallic particles comprise aluminum particles covered by one or more metal or metal oxide layers.
